(19) United States
(12) Patent Application Publication
(10) Pub. No.: US 2022/0263114 A1
(43) Pub. Date: Aug. 18, 2022

(54) SOLID POLYMER ELECTROLYTE COMPRISING A POLYALKENE CARBONATE

(71) Applicants: TotalEnergies SE, COURBEVOIE (FR); UNIVERSITE DE MONTREAL, MONTREAL (CA)

(72) Inventors: David AYMÉ-PERROT, HUNINGUE (FR); Mickaël DOLLÉ, MONTRÉAL (CA); David LEPAGE, MONTRÉAL (CA); Arnaud PRÉBÉ, TERREBONNE (CA)

(73) Assignees: TotalEnergies SE, COURBEVOIE (FR); UNIVERSITE DE MONTREAL, MONTREAL, QC (CA)

(21) Appl. No.: 17/627,197

(22) PCT Filed: Jul. 17, 2020
(86) PCT No.: PCT/EP2020/070336

§ 371 Date: Jan. 14, 2022

(30) Foreign Application Priority Data
Jul. 19, 2019 (EP) 19305958.1

(51) Int. Cl. H01M 10/056; H01M 10/0525

(52) U.S. Cl. CPC H01M 10/056; H01M 10/0525; H01M 2300/0091; H01M 2300/0068; H01M 2300/0082

(57) ABSTRACT

The invention concerns a solid polymer electrolyte comprising a polymer matrix comprising at least one ionic salt, the polymer matrix comprising at least one polyalkene carbonate, at least one second polymer different from the polyalkene carbonate polymer, and at least one alkene carbonate coming from the decomposition of the polyalkene carbonate. The present invention also concerns a method for preparing the solid polymer electrolyte and a battery comprising the solid polymer electrolyte.

### CROSS REFERENCE TO RELATED APPLICATIONS

The present application is a U.S. National Phase Application under 35 U.S.C. § 371 of International Patent Application No. PCT/EP2020/070336 filed Jul. 17, 2020, which claims priority of European Patent Application No. 19305958.1 filed Jul. 19, 2019. The entire contents of which are hereby incorporated by reference.

### FIELD OF THE INVENTION

This invention concerns the field of electrolytes, in particular electrolytes for batteries.

In particular, this invention concerns the field of electrolytes for solid-state batteries.

### BACKGROUND

The marketing of Li-ion batteries starting in the 1990s is a true revolution in the field of energy storage. Thanks to continuous performance improvements, we are seeing exponential growth of this technology. In particular, battery capacities allow for ever greater extensions of the autonomy of portable electronic systems; today, they have reached a threshold that allows for their integration into hybrid or purely electric vehicles. The automobile of tomorrow will be electric. This has resulted in an ever more fast-paced race to improve battery performance and improve their energy density, thus attaining the greatest possible autonomy for electric vehicles.

Furthermore, the safety of on-board energy storage systems becomes more important as their energy density increases. Preventing the thermal release of the electrochemical energy of the battery in the event of an accident is of fundamental importance. This is the issue raised by conventional Li-ion batteries. These have an inflammable organic electrolyte that, if subjected to significant heating, may result in thermal runaway of the battery, which may even cause an explosion. Thus, Li-ion battery packs are currently equipped with complex heat management systems that normally prevent this type of critical scenario, reducing the risk to near-zero levels.

In this context, there are consistent efforts to develop ‘entirely solid’ batteries. The basic idea is to replace the liquid electrolyte with a solid conductive ionic electrolyte. Such a material prevents vaporization and ignition of the electrolyte in the event of overheating, thus de facto preventing thermal runaway. This would allow for simplified and thus less significant (in terms of mass and volume) heat management. Additionally, the use of a solid material as an electrolyte may allow for a different, or greater, range of electrochemical stability compared to conventional solvents (essentially cyclical or linear carbonates). In particular, it would be possible to envisage a solid electrolyte that is stable with metallic lithium, as is the case with polyethylene oxide (PEO), and thus limit/slow down dendritic growth compared to the case of a liquid environment. The use of lithium metal, the most reducing element, as a negative electrode may thus allow for an increase in the operating voltage of the electrochemical cell, and thus its energy density.

Various technical approaches for the production of solid electrolytes have been, and continue to be, researched.

One example are solid polymer electrolytes. Of these, PEO is currently the most reliable solution, but requires an elevated temperature (>60° C.) for effective operation. The ether moieties of PEO allow for the dissociation of a lithium salt (typically LiTFSi), and the chain mobility obtained at high temperature (70-80° C.) then favors Li+ cation diffusion within the polymer matrix. PEO has a maximum conductivity of 10⁻³ S/cm at 80° C. Wide ranges of polymers have been tested, in particular in order to obtain better room temperature (RT) conductivity than is shown by the latter.

In view of this, various past and current efforts relate to the development of gel electrolytes. These are polymer systems in which a liquid electrolyte is trapped, thus favoring ion mobility. Nonetheless, even if the materials have better conductivity (in particular at RT), they still have significant disadvantages, such as significant loss of mechanical strength. Moreover, there is a real risk of electrolyte loss in the event that the system is heated. In other words, the gain in ionic conductivity translates into a loss in terms of battery safety.

In addition to the polymer approaches, numerous inorganic conductive Li+ phases (ceramic or glass) are under investigation. Examples include Li₇La₃Zr₂O₁₂ (LLZO) or substitute compositions [garnet structure], Li₁₊ₓAlₓTi₂₋ₓ(PO4)₃ (LATP) [NASICON structure], and Li_{0.05-3x}La_{0.5+x}TiO₃ (LLTO) [perovskite structure], which are commercially available products. LLZO has the great advantage of being stable in the presence of lithium metal, unlike LATP and LLTO, taking into account the presence of Ti4+ in their structure. These products have promising ‘intra-grain’ conductivity (between 10⁻⁴ and 10⁻³ S/cm at RT). The real issue arises from the grain boundaries; in this case, it is essential to limit the contribution to resistance at the inter-grain interfaces. This is why these materials are conventionally shaped by sintering. The resultant ceramic plates have significant fragility, which is prohibitive in terms of minimizing their thickness and thus incorporating them into cells of several Ah.

### SUMMARY

The objective of the invention is to solve the technical problem of providing an ionic conductive electrolyte that improves the safety of energy storage.

In particular, the objective of the invention is to solve the technical problem of providing a solid ionic conductive electrolyte, in particular for solid-state batteries.

The objective of the invention is to solve the technical problem of providing a solid ionic electrolyte that is conductive at a temperature less than or equal to 60° C.

The objective of the invention is to solve the technical problem of providing a solid Li+ ionic conductive electrolyte.

Another objective of the invention is to solve the technical problem of providing an industrial or industrially applicable method for the preparation an ionic conductive electrolyte, in particular a method that is easily executable and industrially applicable.

Another objective of the invention is to solve the aforementioned technical problems at limited cost.

### DETAILED DESCRIPTION

It was surprisingly discovered that at least one, and preferably all, of the aforementioned technical problems can be solved by providing a solid polymer electrolyte comprising a polymer matrix that comprises at least one ionic salt, wherein the polymer matrix comprises at least one polyalkene carbonate, at least one second polymer other than polyalkene carbonate, and wherein at least the alkene carbonate results from the decomposition of the polyalkene carbonate.

The solutions involving the use of polyalkene carbonates proposed by the prior art include the use of substrates that support a solid electrolyte. One example of this is Adv. Ener. Mater. 2015, 5, 1501082, J. Zhang et al, using an unwoven cellulose membrane as a polyalkene carbonate support (PPC). The PPC and the LiTFSI salt are dissolved in acetonitrile. The homogeneous solution is flowed through the nonwoven cellulose substrate and then evaporated under vacuum (100° C. —24 h). The PPC/cellulose system thus has improved mechanical strength compared to PPC alone, and has good conductivity at and beyond RT (3.0×10⁻⁴ S/cm at 20° C.). However, this solution has the technical disadvantage that the polyalkene carbonate must be deposited on a substrate in order to obtain the desired results. Likewise, Electro. Comm. 66 (2016) 46-48, K. Kimura reports the production of a poly(ethylene carbonate) (PEC) system having a high salt content: 80% LiTFSI. Because the system alone does not have good mechanical strength, a polyimide matrix is used as a porous substrate to support the solid electrolyte. The PEC and the LiTFSI salt are dissolved in acetonitrile. The solution is flowed over the polyimide matrix then evaporated under vacuum (60° C. —24 h). The ionic conductivity of the material is 10⁻⁵ S/cm at 30° C. Here, too, the polyalkene carbonate is deposited on a substrate in order to obtain the desired results, and thus does not constitute a simple enough method for industrial application.

These prior-art solutions are thus unsatisfactory.

This invention further concerns a method for preparing a solid polymer electrolyte according to the invention, wherein the method comprises mixing the polyalkene carbonate and the second polymer by melting or by means of a solvent, wherein the polyalkene and the second polymer are both soluble, and partially decomposing the polyalkene carbonate in alkene carbonate in order to obtain a solid polymer electrolyte according to the invention.

Advantageously, a matrix according to the invention constitutes a self-supported polymer system capable of effectively conducting ions, typically Li⁺ ions, at and beyond RT (typically 20° C.). Thus, the invention makes it possible to overcome to the technical issue of the prior art, namely supporting the polyalkene carbonate on a substrate.

Advantageously, a matrix according to the invention comprises at least one second polymer that is amorphous.

Advantageously, a matrix according to the invention comprises a liquid fraction in the matrix due to the decomposition of a polymer.

Advantageously, a matrix according to the invention has a specific morphology having very good ionic conductivity.

According to the invention, the matrix may comprise one or more polymers other than polyalkene carbonate. Thus, the matrix may comprise one or more polymers of a second type according to the invention.

In one embodiment, the matrix comprises one or more polymers selected from the following group as a second polymer: polyolefin, polycarbonates, halogenated polymers, acrylic polymers, acrylate polymers, methacrylate polymers, vinyl acetate polymers, polyethers, polyesters, polyamides, aromatic polymers, elastomeric polymers, e.g. HNBR, polyisoprenes, rubbery polymers, and any mixture thereof.

Preferably, the second polymer is an elastomer.

Typically, the matrix comprises at least two polymer phases, one of which comprises at least one polyalkene carbonate capable of degrading or reducing to alkene carbonate, the other being at least one second polymer.

Typically, the matrix comprises at least 10 ppm acene carbonate relative to the total mass of the matrix. In one variant, the matrix comprises at least 100 ppm, or at least 1000 ppm, acene carbonate relative to the total mass of the matrix.

Typically, the alkene polycarbonate is broken down to no more than 99 mass %, preferably no more than 70 mass %, even more preferably no more than 50 mass % relative to the initial mass of the alkene polycarbonate. In one variant, the matrix comprises at least 50% acene carbonate relative to the total mass of the matrix.

In one variant, the alkene carbonate is in the form of a monomer.

Advantageously, according to this invention, the matrix comprises no macroseparation between the phase containing the polyalkene carbonate and the phase containing the second polymer.

Thus, the second polymer is selected so as to avoid phase macroseparation. ‘No phase macroseparation’ means that essentially no separation of the pure non-dispersed polymer phase greater in size than several hundred μm is detected. It is possible to search for phase macroseparation by nanoscale infrared Fourier-transform spectroscopy. It is also possible to search for phase macroseparation by means of scanning electron microscopy (SEM).

More generally, all polymer bases may be associated with polyalkene carbonate, provided that the morphology does not include any phase macroseparation as defined above.

Generally, a quantity of polyalkene carbonate relative to the total quantity of polymers in the presence of no more than 80% (mass/mass) allows for adequate mechanical properties to be obtained by electrochemical cycling or in contact with lithium metal, thus allowing for the preparation of a satisfactory solid electrolyte.

In one embodiment, the polyalkene carbonate is present in an amount of 5-80 mass %, preferably 10-70 mass %, relative to the total mass of the polymers of the matrix.

In one embodiment, a quantity of 10-70% (mass/mass) polyalkene carbonate is preferred. In general, a quantity of 15-60% (mass/mass) polyalkene carbonate is more preferred. More preferably, the quantity of polyalkene carbonate ranges from 20-50% (mass/mass).

The polyalkene carbonate does not have a specific molar mass: It may be used alone or in a mixture of different molar masses.

Advantageously, the polymer matrix comprises a polyalkene carbonate having a high molar mass and polyalkene carbonate having a low molar mass relative to one another.

Thus, the oligomers having low molar mass (<15000 g/mol) allow for fluidization of the mixture by plasticizing the polymers having high molar mass (>15000 g/mol). This embodiment advantageously allows for the final viscosity of the mixture to be adjusted relative to the method selected, with or without solvents, or to the final formulation, with or without fillers, or to the final product, having greater or lower thickness. Accordingly, the proportion of polyalkene carbonate having low molar mass relative to the total quantity of polyalkene carbonate typically varies between 0.1 and 99.9%, preferably 5 and 90%, and more preferably 10 and 80%.

One example of a polyalkene carbonate having a low molar mass is a PPC polyol, such as Converge 212-10, and one example of a polyalkene carbonate having a high molar mass is QPac®40.

In one embodiment, the ionic salt is selected from the metal ion salts, the metal of which belongs to column I of the periodic table.

Thus, the one or more ionic salts is/are at least partially dissociated in at least one of the polymer phases.

In one embodiment, the ionic salt is selected from the group consisting of LiBETI, LiC₂F₅SO₃, LiC₄F₉SO₃, LiCF₃SO₃, NaI, NaSCN, NaBr, KI, KBr, LiClO₄, LiBF₄, LiAsF₆, LiPF₆, LiNO₃, Li(CF₃SO₂)₂N, Li(CF₃SO₂)₃C, LiN(SO₂C₂F₅)₂, lithium alkyl fluorophosphates, lithium difluoro(oxalato)borate, lithium bis(oxalato) borate, MTFSiLi, STFSiLi, and any mixture thereof.

In one embodiment, the matrix comprises solid mineral or organic fillers.

Thus, in one embodiment, the matrix comprises solid mineral or organic fillers to confer various properties such as mechanical reinforcement, improved ionic conductivity, or the insertion or removal of a metal ion.

By way of example only, the solid fillers that may improve conductivity include:
both inert fillers such as Al₂O₃, SiO₂, cellulose, starch, that do not conduct cations but that may aid in the transport of ions via the surface interactions of the fillers,
and fillers that are volume-conductive of cations (e.g., ceramics or glasses).

In one embodiment, the matrix comprises solid fillers allowing for the insertion and removal of ‘active’ metal salts. One example is C—LiFePO₄, but all active substances known to persons skilled in the art, such as active substances of positive (e.g. LiCoO₂, LiMnO₄, LiNii_{1/3}Mn_{1/3}Co_{1/3}O₂, . . . ) or negative electrodes (e.g. Li₄Ti₅O₁₂, graphite) should be considered.

In one embodiment, the matrix comprises electrically conductive fillers. One example is conductive carbon black, as well as graphite, graphene, carbon nanofibers, and carbon nanotubes, and a mixture thereof.

In one embodiment, the solid polymer electrolyte is in the form of a film having a thickness of less than 1 mm.

A film according to the invention typically has a thickness of 10-500 μm, e.g. 80-300 μm, and typically 90-200 μm.

Typically, the method for preparation according to the invention comprises mixing the polymers, including the polyalkene carbonate and the second polymer, either by the dry method for ‘melted polymers’ (also known as the melt method) or by the solvent method (also known as the wet method).

In one embodiment, the method comprises heating during the mixing of the polyalkene carbonate and the second polymer.

Advantageously, in one embodiment, the melt mixing is carried out, in whole or in part, or followed by heating at a temperature sufficient for the partial breakdown of the polyalkene carbonate to alkene carbonate.

In one variant, the melt mixing is carried out entirely at a temperature sufficient for partial breakdown of the polyalkene carbonate to alkene carbonate.

In one variant, the melt mixing is carried out in part, preferably at the end of the mixing, at a temperature sufficient for partial breakdown of the polyalkene carbonate to alkene carbonate.

In one embodiment, the mixing by the solvent method is carried out at RT (typically 20° C.), and then the mixture is dried at a temperature sufficient to eliminate the solvent and for partial breakdown of the polyalkene carbonate to alkene carbonate.

Preferably, in the liquid method, a solvent is used having a boiling point below the decomposition temperature of the polyalkene carbonate.

In one embodiment, the method comprises melt mixing of the polyalkene carbonate and the second polymer, wherein the mixing is carried out at least partially in contact with inorganic fillers that promote the partial breakdown of the polyalkene carbonate to alkene carbonate.

In one embodiment, the method comprises adding a reducing metal, e.g. lithium, in conditions effecting the partial decomposition of the polyalkene carbonate to alkene carbonate after drying. Advantageously, in the presence of such a metal, heating is not required in order to obtain the partial breakdown of the polyalkene carbonate to alkene carbonate.

Preferably, the mixture is then shaped into a film and then dried.

Advantageously, the mixing of the polymers makes it possible to obtain a film that requires no substrate, unlike the aforementioned prior art.

Preferably, the mixture is dried during a drying step.

Typically, the mixture is dried for sufficient time to obtain the desired drying, e.g. for at least one hour at 60° C. under vacuum. The vacuum is produced under conditions known to persons skilled in the art, e.g. by means of a vacuum pump.

Preferably, in one variant, following drying in the liquid method or at the end of the mixing by the melt method, the method is heated to a temperature that results in the in-situ release of an alkene carbonate fraction within the polymer matrix. Thus, in one variant, the method comprises heating to a temperature sufficient to partially break down the polyalkene carbonate to alkene carbonate (‘conditioning temperature’).

Advantageously, in the presence of a metal that promotes the partial breakdown of the polyalkene carbonate to alkene carbonate, the conditioning temperature may be reduced, e.g. to prepare the solid electrolyte in contact with a metal anode, e.g. lithium metal. Advantageously, in one embodiment, the step of heating to the conditioning temperature occurs on a battery comprising the solid polymer electrolyte, e.g. prior to marketing or use.

In one embodiment, the method comprises heating the solid polymer electrolyte to the conditioning temperature following mixing.

For example, the conditioning temperature is greater than 80° C., e.g. greater than 100° C., or e.g. greater than 120° C.

In one embodiment, the conditioning temperature is greater than 150° C., e.g. greater than 170° C.

Thus, advantageously, in one embodiment, in the method according to the invention, the mixture obtained is treated at the conditioning temperature for sufficient time to improve its ionic conductivity (typically 1-30 min), then returned to ambient temperature.

In one variant, the method comprises adding specific additives to the polymer mixture in order to improve and/or optimize the method for producing the solid polymer electrolyte.

In one variant, the method comprises crosslinking the one or more second polymers, preferably during mixing with the polyalkene carbonate. This crosslinking may take place solely on the one or more second polymers (other than polyalkene carbonate) or together with the polyalkene carbonates to the extent that this does not impede the in-situ generation of the corresponding alkene carbonate.

In one variant, the method includes adding one or more compounds forming crosslinking agents for the one or more second polymers mixed with the polyalkene carbonate.

In one variant, the method comprises adding one or more agents promoting the crosslinking and homogenization thereof. Examples of crosslinking agents include organic peroxides or triallyl cyanurate as a coagent. However, it is likewise possible to make use of all compounds allowing for the crosslinking of the second polymer, such as photoinitiators or sulphur compounds, which, e.g., are typical of the crosslinking of rubbers. It is also possible to use chemical reactions of bifunctional compounds on the pendant chains of the second polymer (if any), such as maleic anhydride, epoxy, or acid, alcohol, amine, amide, or ester moieties, given that a reaction on pendant moieties results in the formation of bridges between polymer chains and, accordingly, the crosslinking of the system. Advantageously, crosslinking increases the cohesion of the matrix. Thus, the use of a crosslinking agent and, if applicable, a coagent is useful without being necessary to the invention, and depends directly from the intended application and the intended method.

The invention also concerns an electrode comprising at least one solid polymer electrolyte according to the invention or obtainable by a method according to the invention.

The invention also concerns a battery comprising at least one solid polymer electrolyte according to the invention or obtainable by a method according to the invention.

In one variant, the battery is a solid polymer electrolyte lithium battery.

In particular, the solid polymer electrolyte in film form may be used as the membrane of an energy storage battery. The membrane is typically inserted between two electrodes of the battery.

### BRIEF DESCRIPTION OF THE DRAWINGS

FIG. 1 shows the voltage (V) as a function of time (h) of a system having a solid polymer electrolyte according to example 2b between two lithium metals at 60° C.;

FIG. 2 shows a solid polymer electrolyte system according to example 4 between two lithium metal electrodes at 60° C.; a short-circuit occurs within less than half an hour of use;

FIG. 3 shows a first discharge of an electrode having the composition described in example 5;

FIG. 4 shows the cycle stability of a half-cell using a C-LFP electrode (example 5) vs. Li metal.

### EXAMPLES

Percentages are by mass relative to the total mass of the composition in question, unless otherwise indicated.

The temperature is RT (20° C.) unless otherwise indicated. Pressure is atmospheric (101325 Pa) unless otherwise indicated.

Electrochemical analyses were carried out using electrochemical impedance spectroscopy (MTZ-35, BioLogic device) with a temperature control accessory (ITS device, BioLogic). The morphology was obtained by SEM images.

### Example 1: Solid Electrolyte Prepared by Melt Method (or Dry Method)

1.a. The mixture was produced by including 10.1 g HNBR (zetpol 2010), 5.5 g PPC (QPac40), 5.3 g PPC polyol (Converge 212-10), and 8.5 g LiTFSI in an internal mixer. Following the addition of the ingredients, they were mixed at 85±10° C. for 5 min.

TABLE 1

| Substance | % (m/m) |
|---|---|
| HNBR (Zetpol 2010L) | 34.4 |
| PPC (QPac40) | 18.8 |
| PPC (Converge212-10) | 17.9 |
| LiTFSI | 28.9 |

% (m/m): mass % relative to total mass of the substance mixed.

The final mixture was shaped into several films approximately 100 μm in thickness by calendaring using a Dr Collin Teachline CR72T. The films are then dried for at least 12 h at 60° C. under a vacuum generated by an Edwards RV12 pump.

1.b. A film having the same composition was conditioned for 1 h at 190° C.

The conductivity of the various films was measured. The results are shown in table 5 below.

### Example 2: Solid Electrolyte Prepared by Melt Method

2.a. The mixture was produced by including 13.4 g HNBR (zetpol 2010), 2.7 g PPC (QPac40), 2.8 g PPC polyol (Converge 212-10), and 8.2 g LiTFSI in an internal mixer. Following the addition of the ingredients, they were mixed at 85±10° C. for 5 min.

TABLE 2

| Substance | % (m/m) |
|---|---|
| HNBR (Zetpol 2010L) | 49.4 |
| PPC (QPac40) | 10.3 |
| PPC (Converge212-10) | 10.0 |
| LiTFSI | 30.3 |

% (m/m): mass % relative to total mass of the substance mixed.

The final mixture was shaped into several films approximately 100 μm in thickness by calendaring using a Dr Collin Teachline CR72T. The films are then dried for at least 12 h at 60° C. under a vacuum generated by an Edwards RV12 pump.

2.b. A film having the same composition was conditioned for 1 h at 190° C.

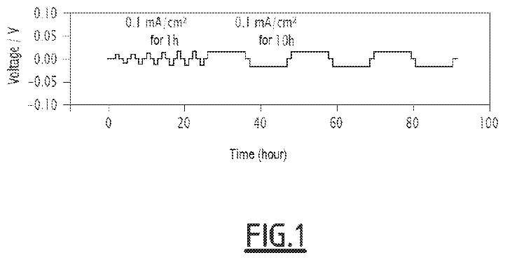

Lastly, the conductivity of the various films was measured; the results are shown in table 5. The polarization behavior of the conditioned film is tested between 2 lithium metal electrodes subjected to different current densities (FIG. 1.).

### Example 3: Solid Electrolyte Prepared by Melt Method

3.a. The mixture was produced by including 8.4 g HNBR (zetpol 0020), 5.6 g PPC (QPac40), 5.3 g PPC polyol (Converge 212-10), and 8.4 g LiTFSI in an internal mixer. Following the addition of the ingredients, they were mixed at 85±10° C. for 5 min.

TABLE 3

| Substance | % (m/m) |
|---|---|
| HNBR (Zetpol 0020) | 30.4 |
| PPC (QPac40) | 20.1 |
| PPC (Converge212-10) | 19.2 |
| LiTFSI | 30.3 |

% (m/m): mass % relative to total mass of the substance mixed.

The final mixture was shaped into several films approximately 100 μm in thickness by calendaring using a Dr Collin Teachline CR72T. The films are then dried for at least 12 h at 60° C. under a vacuum generated by an Edwards RV12 pump.

3.b. A film having the same composition was conditioned for 1 h at 190° C.

Lastly, the conductivity of the various films was measured. The results are shown in table 5 below.

### Example 4—Comparative Example

In a 30 ml internal mixture, the mixture was produced by including 12.2 g PPC (QPac40) and 11.6 g PPC polyol (Converge 212-10), as well as 10.2 g LiTFSI. Following the addition of the ingredients, they were mixed at 65±5° C. for 5 min.

TABLE 4

| Substance | % (m/m) |
|---|---|
| PPC (QPac40) | 35.9 |
| PPC (Converge212-10) | 34.1 |
| LiTFSI | 30.0 |

% (m/m): mass % relative to total mass of the substance mixed.

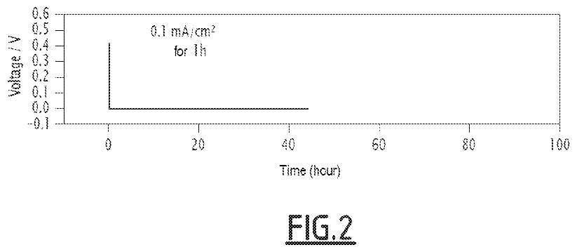

The conductivity of the various films was measured; the results are shown in table 5. The polarization behavior of the conditioned film is tested between 2 lithium metal electrodes subjected to 0.1 mA/cm2 (FIG. 2.).

TABLE 5
Results

Ionic conductivity (S/cm)

| | Before | After |
|---|---|---|
| | Conditioning | Conditioning |
| | (a) | (b) |
| | 60° C. | 60° C. |
| Example 1 | 2.4 10⁻⁶ | 5.7 10⁻⁵ |
| Example 2 | 4.3 10⁻⁶ | 3.3 10⁻⁵ |
| Example 3 | 1.2 10⁻⁵ | 2.1 10⁻⁴ |

| | |
|---|---|
| Example 4 | ** |
| (comparative) | |

** The membrane is liquid at 60° C.

### Example 5: Electrode Including the Solid Polymer Electrolyte—Prepared by the Melt Method

In a 30 ml internal mixer, 4.8 g HNBR (zetpol 2010), 3.0 g PPC (QPac40), 2.9 g PPC polyol (Converge 212-10), 4.6 g LiTFSI, 33.5 g LiFePO4 (Lifepower P2), 2.6 g carbon black (Timcal C65) [sic]. Following the addition of the ingredients, they were mixed at 85±10° C. for 5 min.

The final mixture has the following composition:

TABLE 6

| | % |
|---|---|
| Substance | (m/m)t |
| HNBR (Zetpol 2010) | 9.3 |
| PPC (QPac40) | 5.9 |
| PPC (Converge212-10) | 5.6 |
| LiTFSI | 9 |
| LiFePO₄ | 65.2 |
| C65 | 5 |

% (m/m): mass % relative to total mass of the substance mixed.

The final mixture was shaped into several films approximately 50 μm in thickness by calendaring using a Dr Collin Teachline CR72T. The films are then plated on a current collector and then dried for at least 12 h at 60° C. under a vacuum generated by an Edwards RV12 pump.

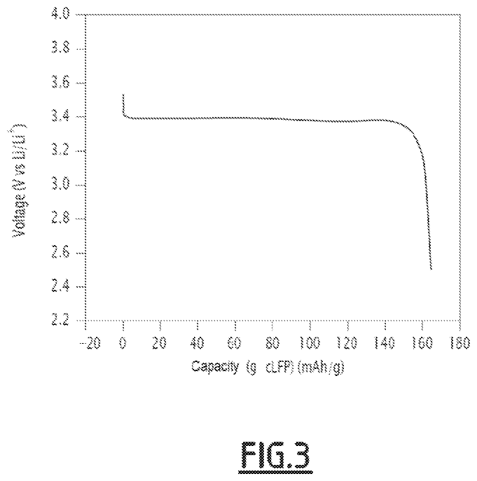

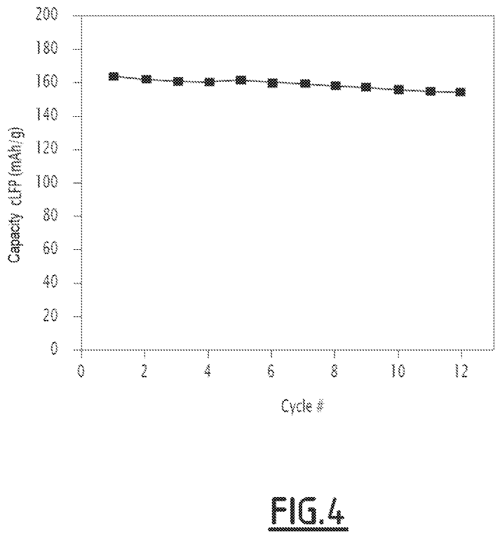

The electrode thus obtained was assembled as a button cell using the mixture of example 1 as a separator of a thickness of approximately 75 μm and lithium metal as an anode. The two films were conditioned for 1 h at 190° C. before being assembled as a button cell. We obtained a capacity of 164 mAh/g LFP at 60° C. on the first discharge at a speed of C/20 (FIG. 3) and is stable for at least 12 cycles (FIG. 4).

1. A solid polymer electrolyte comprising a polymer matrix that comprises at least one ionic salt, wherein the polymer matrix comprises at least one polyalkene carbonate, at least one second polymer other than polyalkene carbonate, and at least the alkene carbonate resulting from the decomposition of polyalkene carbonate.

2. The solid polymer electrolyte according to claim 1, characterized in that the polyalkene carbonate is present in an amount of 5-80 mass %, preferably 10-70 mass %, relative to the total mass of the polymers of the matrix.

3. The solid polymer electrolyte according to claim 1, wherein the polymer matrix comprises a polyalkene carbonate having a high molar mass and a polyalkene carbonate having a low molar mass relative to one another.

4. The solid polymer electrolyte according to claim 1, wherein the ionic salt is selected from the salts of a metal ion, the metal of which belongs to column I of the periodic table.

5. The solid polymer electrolyte according to claim 1, wherein the ionic salt is selected from the group consisting of LiBETI, LiC₂F₅SO₃, LiC₄F₉SO₃, LiCF₃SO₃, NaI, NaSCN, NaBr, KI, KBr, LiClO₄, LiBF₄, LiAsF₆, LiPF₆, LiNO₃, Li(CF₃SO₂)₂N, Li(CF₃SO₂)₃C, LiN(SO₂C₂F₅)₂, lithium alkyl fluorophosphates, lithium difluoro(oxalato)borate, lithium bis(oxalato) borate, MTFSiLi, STFSiLi, and any mixture thereof.

6. The solid polymer electrolyte according to claim 1, wherein the second polymer is selected from polyolefins, polycarbonates, halogenated polymers, acrylic polymers, acrylate polymers, methacrylate polymers, vinyl acetate polymers, polyethers, polyesters, polyamides, aromatic polymers, elastomeric polymers, e.g. HNBR, polyisoprenes, rubbery polymers, and any mixture thereof.

7. The solid polymer electrolyte according to claim 1, wherein the matrix comprises no macroseparation between the phase containing the polyalkene carbonate and the phase containing the second polymer.

8. The solid polymer electrolyte according to claim 1, wherein the matrix comprises solid mineral or organic fillers.

9. The solid polymer electrolyte according to claim 1, wherein the solid polymer electrolyte is in the form of a film having a thickness of less than 1 mm.

10. The solid polymer electrolyte according to claim 1, wherein the polymer matrix is obtained by mixing the polyalkene carbonate and the second polymer by melting or by means of a solvent, wherein the polyalkene carbonate and the second polymer are both soluble.

11. A method for preparing a solid polymer electrolyte according to claim 1, wherein the method comprises mixing the polyalkene carbonate and the second polymer by melting or by means of a solvent, wherein the polyalkene and the second polymer are both soluble, and partially decomposing the polyalkene carbonate in alkene carbonate in order to obtain a solid polymer electrolyte according to claim 1.

12. The method according to claim 11, wherein the method comprises heating the solid polymer electrolyte.

13. An electrode comprising at least one solid polymer electrolyte according claim 1 or obtainable by a method according to claim 11.

14. A battery comprising at least one solid polymer electrolyte according to claim 1 or obtainable by a method according to claim 11.

15. The battery according to claim 14, characterized in that the battery is a solid polymer electrolyte lithium battery.
